(19) United States
(12) Patent Application Publication
(10) Pub. No.: US 2012/0241627 A1
(43) Pub. Date: Sep. 27, 2012

(54) RADIOLOGICAL IMAGE DETECTION APPARATUS AND METHOD OF MANUFACTURING THE SAME

(75) Inventors: Kazuhiro NODA, Kanagawa (JP); Hideyuki NOUMURA, Kanagawa (JP); Hiroaki SHINOHARA, Kanagawa (JP)

(73) Assignee: FUJIFILM CORPORATION, Tokyo (JP)

(21) Appl. No.: 13/428,518

(22) Filed: Mar. 23, 2012

(30) Foreign Application Priority Data
Mar. 25, 2011 (JP) 2011-067839

(51) Int. Cl. G01T 1/202; B32B 37/12; B32B 38/00

(52) U.S. Cl. 250/361 R; 156/272.2

(57) ABSTRACT

A radiological image detection apparatus includes: a radiation image conversion panel including: a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, a surface of the protective film being subjected to plasma processing; a sensor panel detecting the fluorescent light emitted from the phosphor; and an adhesive layer which is sandwiched between the protective film and a photodetecting surface of the sensor panel and with which the radiation image conversion panel and the sensor panel are bonded to each other, a thickness of the adhesive layer being in a range of 10 to 40 μm.

### CROSS-REFERENCE TO RELATED APPLICATIONS

This application is based on and claims priority under 35 USC 119 from Japanese Patent Application No. 2011-067839 filed on Mar. 25, 2011; the entire content of which is incorporated herein by reference.

### BACKGROUND

1. Technical Field

The present invention relates to a radiological image detection apparatus and a method of manufacturing the same.

2. Related Art

In recent years, radiological image detection apparatuses using an FPD (flat panel detector) which detects a radiation image and generates digital image data have been put into practice and have spread rapidly because they enable an immediate check of an image unlike conventional imaging plates. Various types of such radiological image detection apparatuses are available and one of those types is an indirect conversion type.

An indirect conversion type radiological image detection apparatus is equipped with a scintillator using a fluorescent material such as CsI which emits fluorescent light when exposed to radiation and a sensor panel for detecting the fluorescent light emitted from the scintillator. Radiation that has passed through a subject is converted by the scintillator into fluorescent light, which is converted photoelectrically by photoelectric conversion elements of the sensor panel. An electrical signal (digital image data) is thus generated.

A technique of forming a scintillator as a group of columnar crystals in which a fluorescent material such as CsI have grown into columnar shape by vapor-phase deposition is proposed. Columnar crystals grown by vapor-phase deposition suppress diffusion of fluorescent light because they do not contain impurities such as a binding agent and have a light guide effect of guiding fluorescent light generated therein in the crystal growth direction. Thus, this technique can increase the sensitivity and the image sharpness of a radiological image detection apparatus.

Among radiological image detection apparatuses having a scintillator that is formed as a group of columnar crystals of a fluorescent material are a direct evaporation type device in which a scintillator is formed directly on a sensor panel (refer to Patent document 1 (JP-A-2006-78472), for example) and an indirect evaporation type device in which a radiation image conversion panel having a scintillator formed on a support substrate is bonded to a sensor panel (refer to Patent document 2 (JP-A-2011-017683), for example).

An example of the support substrate of the support substrate of the radiation image conversion panel is an aluminum plate. Since CsI or the like which is used as the fluorescent material exhibits deliquescence, the surface of the scintillator which is formed on the support substrate is covered with a moistureproof protective film. An example of the protective film is a parylene film formed by vapor-phase deposition. The radiation image conversion panel and the sensor panel are bonded to each other with an adhesive layer sandwiched between them.

An initial crystal growth stage layer of the scintillator is insufficient in columnar crystallization. In the direct evaporation type radiological image detection apparatus, the initial crystal growth stage layer of the scintillator is disposed on the sensor panel side. On the other hand, in the indirect evaporation type radiological image detection apparatus, a final crystal growth stage layer (which is sufficient in columnar crystallization) of the scintillator is disposed on the sensor panel side. Therefore, the indirect evaporation type radiological image detection apparatus can attain higher image quality.

However, in the indirect evaporation type radiological image detection apparatus, as described above, an aluminum plate, for example, is used as the support substrate of the radiation image conversion panel and the substrate of the sensor panel is generally a glass plate. As a result, a warp may occur due to the difference between the linear expansion coefficients of the two substrates. If the adhesive layer is made thicker to reduce the stress that is caused by such a warp, the distance between the scintillator and the sensor panel may become so large that the image sharpness degrades being affected by scattering or the like occurring between them. On the other hand, if the adhesive layer is thin, the stress that is caused by a warp may not be reduced sufficiently, in which case local peeling may occur between the scintillator and the sensor panel.

The protective film also exists between the scintillator and the sensor panel. If the protective film is thick, the distance between the scintillator and the sensor panel may be so large that the image sharpness degrades being affected by scattering or the like occurring between them. On the other hand, if the protective film is thin, the moisture resistance may become so low that the scintillator becomes deliquescent and the image sharpness is lowered also in this case. Furthermore, minute asperities of the fluorescent light emission surface (which is a collection of tip portions of columnar crystals) of the scintillator cannot be reduced, which may lower the adhesion to the adhesive layer and cause local peeling between the scintillator and the sensor panel.

### SUMMARY

An illustrative aspect of the invention is to attain both of high image quality and high durability of a radiological image detection apparatus.

(1) A radiological image detection apparatus includes: a radiation image conversion panel including: a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, a surface of the protective film being subjected to plasma processing; a sensor panel detecting the fluorescent light emitted from the phosphor; and an adhesive layer which is sandwiched between the protective film and a photodetecting surface of the sensor panel and with which the radiation image conversion panel and the sensor panel are bonded to each other, a thickness of the adhesive layer being in a range of 10 to 40 μm.

(2) A method of manufacturing a radiological image detection apparatus comprising: a radiation image conversion panel including a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, and a sensor panel detecting the fluorescent light emitted from the phosphor, includes: subjecting a surface of the protective film to plasma processing; and bonding the radiation image conversion panel and the sensor panel to each other with an adhesive layer which is sandwiched between the plasma-processed surface of the protective film and the photodetecting surface of the sensor panel and has a thickness that is in a range of 10 to 40 μm.

With the configuration and the process, since the protective film is subjected to plasma processing, the adhesion between the protective film and the adhesive film is increased, whereby the phosphor and the sensor panel can be prevented from peeling off each other due to a warp. As a result, the adhesive layer can be made thinner and the image sharpness can thereby be increased.

### BRIEF DESCRIPTION OF THE DRAWINGS

FIG. 1 shows the configuration of an example radiological image detection apparatus according to an embodiment of the present invention.

FIG. 2 shows the configuration of a sensor panel of the radiological image detection apparatus of FIG. 1.

FIG. 3 schematically shows the configuration of a radiation image conversion panel of the radiological image detection apparatus of FIG. 1.

FIG. 4 is an electron microscope photograph of a cross section, taken along line IV-IV in FIG. 3, of a phosphor of the radiation image conversion panel.

FIG. 5 is an electron microscope photograph of a cross section, taken along line V-V in FIG. 3, of the phosphor of the radiation image conversion panel.

FIG. 6 is a graph showing a relationship between the thickness of an adhesive layer and the MTF value in the radiological image detection apparatus of FIG. 1.

FIG. 7 is a graph showing a relationship between the thickness of the adhesive layer and the number of pixel defects in the radiological image detection apparatus of FIG. 1.

### DETAILED DESCRIPTION

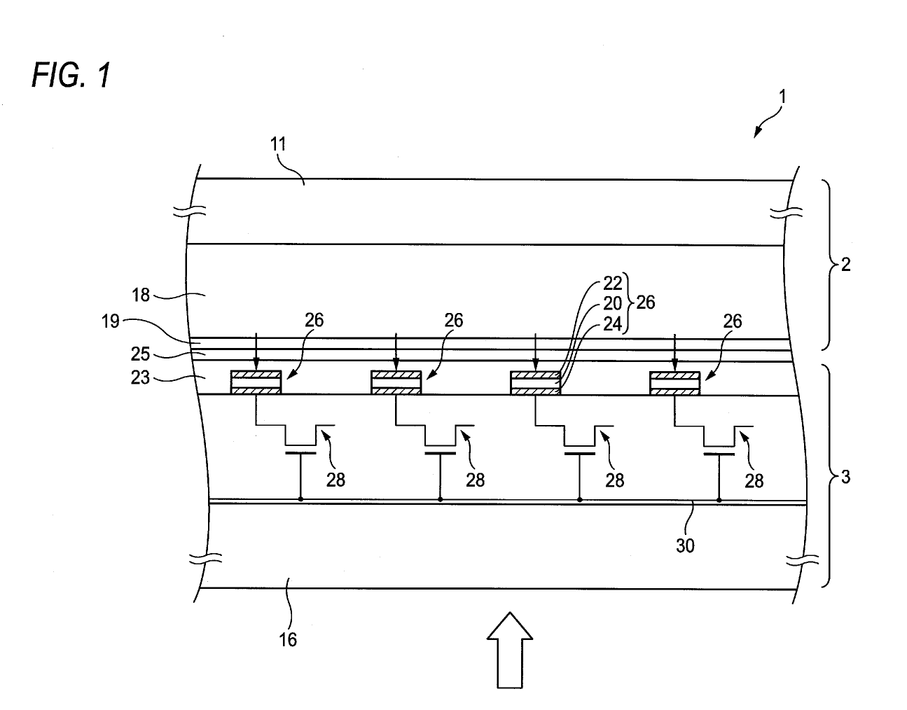

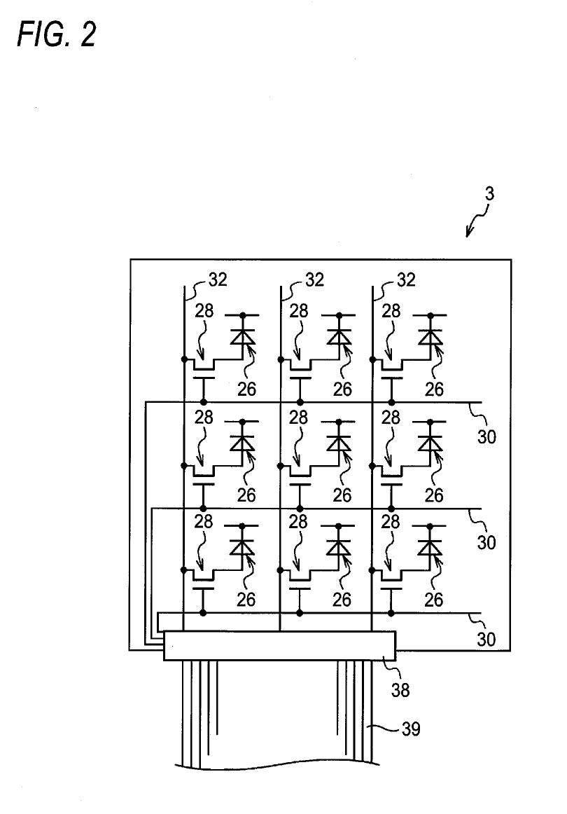

FIG. 1 shows the configuration of an example radiological image detection apparatus 1 according to an embodiment of the present invention. FIG. 2 shows the configuration of a sensor panel 3 of the radiological image detection apparatus of FIG. 1.

The radiological image detection apparatus 1 is equipped with a radiation image conversion panel 2 having a scintillator (phosphor) 18 which emits fluorescent light when exposed to radiation and the sensor panel 3 having two-dimensionally-arranged photoelectric conversion elements 26 which photoelectrically converts the fluorescent light emitted from the scintillator 18.

The radiation image conversion panel 2 has a support substrate 11 and the scintillator 18 is formed on the support substrate 11. The radiation image conversion panel 2 is bonded to the sensor panel 3 in such a manner that the fluorescent light emission surface, located on the side opposite to the support substrate 11, of the scintillator 18 is opposed to the two-dimensionally-arranged photoelectric conversion elements 26 (photodetecting unit).

The radiological image detection apparatus 1 according to the embodiment is what is called an irradiation side sampling (ISS) radiological image detection apparatus in which radiation is applied from the side of the sensor panel 3. Radiation is applied from the side of the sensor panel 3, passes through the sensor panel 3, and shines on the scintillator 18. Fluorescent light is produced in the scintillator 18 in response to incident radiation and then converted photoelectrically by the photoelectric conversion elements 26 of the sensor panel 3. The thus-configured radiological image detection apparatus 1 exhibits high sensitivity because the radiation incidence side (which emits more fluorescent light) of the scintillator 18 is disposed adjacent to the photoelectric conversion elements 26.

The sensor panel 3 is equipped with a TFT substrate 16 in which switching devices 28 which are thin-film transistors (TFTs) are formed on an insulative substrate. The two-dimensionally-arranged photoelectric conversion elements 26 are formed on the TFT substrate 16.

Each photoelectric conversion element 26 is composed of a photoconductive layer 20 which generates charge when receiving fluorescent light from the scintillator 18 and a pair of electrodes 22 and 24 formed on the front surface and the back surface of the photoconductive layer 20. The electrode 22 formed on the scintillator-18-side surface of the photoconductive layer 20 is a bias electrode for applying a bias voltage to the photoconductive layer 20, and the electrode 24 formed on the opposite surface of the photoconductive layer 20 is a charge collection electrode for collecting charge that is generated in the photoconductive layer 20.

The switching devices 28 are arranged two-dimensionally in the TFT substrate 16 so as to correspond to the respective two-dimensionally-arranged photoelectric conversion elements 26. The charge collection electrode 24 of each photoelectric conversion element 26 is connected to the corresponding switching device 28 in the TFT substrate 16. Charge that is collected by each charge collection electrode 24 is read out via the corresponding switching device 28.

The TFT substrate 16 is provided with plural gate lines 30 which extend in one direction (row direction) and turn on or off the switching devices 28 and plural signal lines (data lines) 32 which extend in the direction (column direction) that is perpendicular to the gate lines 30 and read charges via on-state switching devices 28. A connection terminal 38 to which the individual gate lines 30 and the individual signal lines 32 are connected is disposed at a peripheral position in the TFT substrate 16. As shown in FIG. 2, the connection terminal 38 is connected to a circuit board (not shown) via a connection circuit 39. The circuit board is equipped with a gate line driver as an external circuit and a signal processing section.

The switching devices 28 are turned on sequentially on a row-by-row basis according to signals that are supplied from the gate driver via the gate lines 30. Charges that are read out via on-state switching devices are transmitted as charge signals by the signal lines 32 and input to the signal processing section. In this manner, charges are read out sequentially on a row-by-row basis and converted into electrical signals by the signal processing section, whereby digital image data are generated.

The TFT substrate 16 is formed with a planarization layer 23 which covers the photoelectric conversion elements 26 and thereby flattens the surface of the TFT substrate 16. An adhesive layer 25 is formed on the planarization layer 23, and the radiation image conversion panel 2 and the sensor panel 3 are bonded to each other with the adhesive layer 25. The radiation image conversion panel 2 and the scintillator 18 will be described below in detail.

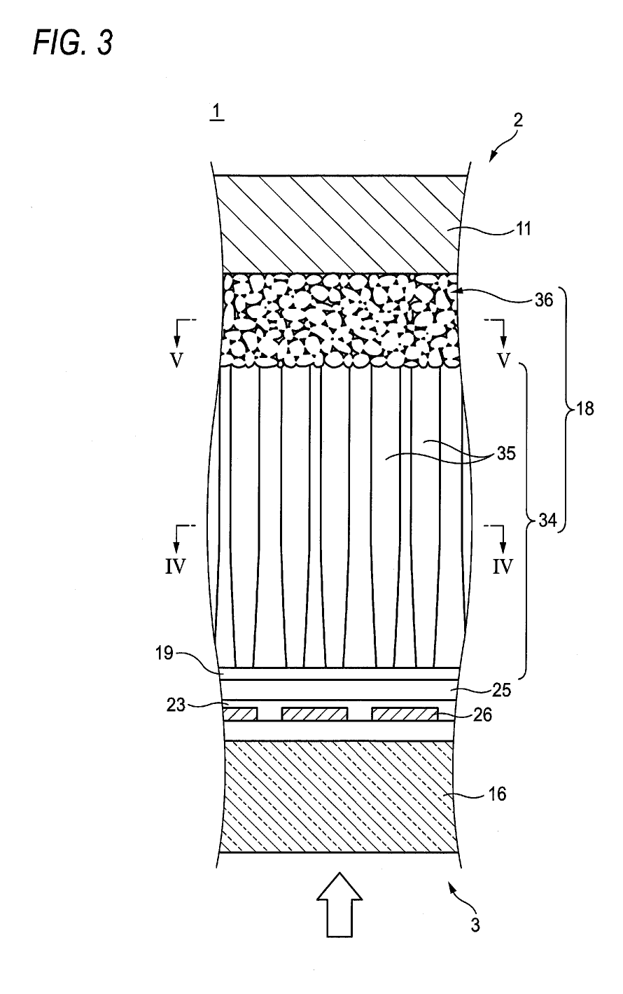

FIG. 3 schematically shows the configuration of the radiation image conversion panel 2.

The radiation image conversion panel 2 has the support substrate 11 and the scintillator 18 which is formed on the support substrate 11.

The support substrate 11 may be any substrate as long as the scintillator 18 can be formed thereon. However, it is preferable that support substrate 11 be a metal plate made of aluminum or an aluminum alloy which reflects fluorescent light emitted from the scintillator 18.

Example fluorescent materials of the scintillator 18 are CsI:Tl (thallium-activated cesium iodide), NaI:Tl (thallium-activated sodium iodide), and CsI:Na (sodium-activated cesium iodide). Among these materials, CsI:Tl is preferable in that its emission spectrum matches the peak (around 550 nm) of the spectral sensitivity of the a-Si photodiode.

The scintillator 18 is composed of a columnar portion 34 which is located on the side opposite to the support substrate 11 and a non-columnar portion 36 which is located on the side of the support substrate 11. As described later in detail, the columnar portion 34 and the non-columnar portion 36 are formed continuously on the support substrate 11 as stacked layers by vapor-phase deposition. Although the columnar portion 34 and the non-columnar portion 36 are made of the same fluorescent material, they may be different in the content of the activator such as Tl.

The columnar portion 34 is a group of columnar crystals 35 in which crystals of the fluorescent material have grown into columnar shape, the fluorescent material which emits fluorescent light. Gaps are formed between the adjoining columnar crystals 35 and, as such, the columnar crystals 35 are independent of each other. There may occur a phenomenon that plural neighboring columnar crystals 35 are connected together into a single columnar crystal.

The non-columnar portion 36 is a collection of relatively small crystals of the fluorescent material. In the non-columnar portion 36, no clear gaps are formed between the constituent crystals because they are connected to or laid on each other irregularly. The non-columnar portion 36 may contain amorphous bodies of the fluorescent material.

The fluorescent light emission surface (which is a collection of relatively sharp tip portions of the columnar crystals 35) of the scintillator 18 of the radiation image conversion panel 2 is bonded to the sensor panel 3 so as to be opposed to the two-dimensionally-arranged photoelectric conversion elements 26 of the sensor panel 3. In the scintillator 18, the columnar portion 34 which is a collection of columnar crystals 35 is located on the radiation incidence side.

Fluorescent light generated in each columnar crystal 35 of the columnar portion 34 is prevented from being diffused because it is subjected to total reflection repeatedly in the columnar crystal 35 because of the difference between the refractive indices of the columnar crystal 35 and the air that occupies the gaps around the columnar crystal 35. The fluorescent light that has traveled through each columnar crystal 35 is thus guided to the photoelectric conversion element 26 opposed to it. This mechanism increases the image sharpness.

Part of fluorescent light that is generated in the columnar crystals 35 of the columnar portion 34 and goes toward the side opposite to the sensor panel (i.e., toward the support substrate 11) is reflected by the non-columnar portion 36 to the side of the sensor panel 3. This increases the phosphor utilization efficiency and the sensitivity.

Furthermore, where the support substrate 11 is a metal plate made of aluminum or an aluminum alloy, part of fluorescent light that is generated in the columnar crystals 35 of the columnar portion 34 and goes toward the support substrate 11 can be reflected to the side of the sensor panel 3. This also contributes to increasing the phosphor utilization efficiency and the sensitivity.

Each columnar crystal 35 is relatively thin at an initial stage of growth and becomes thicker as the crystal growth proceeds. In a portion, joined to the non-columnar portion 36, of the columnar portion 34, many small-diameter columnar crystals 35 stand together and a large number of relatively large gaps extend in the crystal growth direction to produce a large space ratio. On the other hand, the non-columnar portion 36 is formed by relatively small crystals and aggregates of relatively small crystals and individual gaps are relatively small. The non-columnar portion 36 is denser and smaller in space ratio than the columnar portion 34. The presence of the non-columnar portion 36 between the support substrate 11 and the columnar portion 34 increases the adhesion between the support substrate 11 and the scintillator 18. As a result, the scintillator 18 is made more resistant to stress that is caused by, for example, impact or a warp due to the difference between the linear expansion coefficients of the support substrate 11 and the TFT substrate 16. Thus, the scintillator 18 is prevented from being peeled off the support substrate 11.

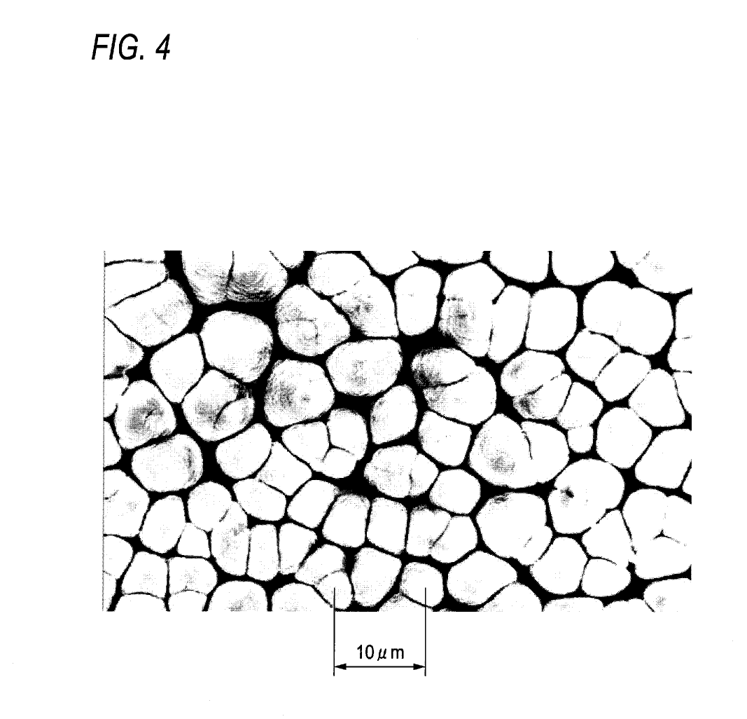

FIG. 4 is an electron microscope photograph of a cross section of the scintillator 18 taken along line IV-IV in FIG. 3.

As seen from FIG. 4, in the columnar portion 34, the columnar crystals 35 have approximately uniform diameters in a plane that is perpendicular to the crystal growth direction and gaps are formed around each columnar crystal 35 (i.e., the columnar crystals 35 exist independently of each other). From the viewpoints of the light guide effect, mechanical strength, and the prevention of pixel defects, it is preferable that the crystal diameter (column diameter) of the columnar crystals 35 be in the range of 2 to 8 μm. If the column diameter is too small, the columnar crystals 35 become insufficient in mechanical strength and may be damaged due to impact or the like. If the column diameter is too large, the number of columnar crystals 35 per photoelectric conversion element 26 becomes small and hence the probability may be increased that when a crack develops in a columnar crystal 35 the corresponding photoelectric conversion element 26 is made defective. The number of columnar crystals 35 per photoelectric conversion element 26 is typically several tens to several hundreds although it depends on the size of the photoelectric conversion elements 26.

The term “column diameter” as used herein means a maximum crystal diameter that is obtained when a columnar crystal 35 is viewed from above in the growth direction. More specifically, a “column diameter” is determined by observing columnar crystals 35 with a SEM (scanning electron microscope) from above in the growth direction. An observation is carried out at such a magnification (about ×2,000) that 100 to 200 columnar crystals 35 can be observed, and an average of measured maximum column diameter values of all columnar crystals 35 observed in one electrograph is employed as a “column diameter.” Column diameter values (μm) are read to three decimal places and their average is rounded off to nearest tenth according to JIS Z 8401.

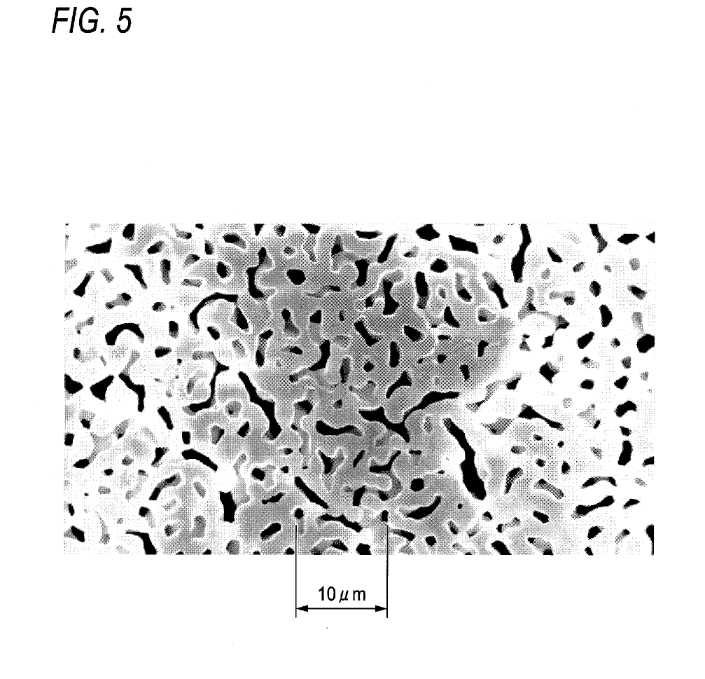

FIG. 5 is an electron microscope photograph of a cross section of the scintillator 18 taken along line V-V in FIG. 3.

As seen from FIG. 5, in the non-columnar portion 36, unlike in the columnar portion 34, no clear gaps are formed between the constituent crystals are connected to or laid on each other irregularly. From the viewpoints of adhesion and light reflection, it is preferable that the diameter of the constituent crystals of the non-columnar portion 36 be in the range of 0.5 to 7.0 μm. If the crystals are too small in diameter, the gaps occupy only a small space (almost no space) and hence the light reflecting function may be lowered. If the crystals are too large in diameter, the flatness becomes low and hence the adhesion to the support substrate 11 may be lowered. From the viewpoint of light reflection, it is preferable that the constituent crystals of the non-columnar portion 36 be approximately spherical in shape.

In the non-columnar portion 36, where crystals are connected to each other, a “crystal diameter” is determined in the following manner. Where crystals are connected to each other, each line connecting recesses between adjoining crystals is regarded as their boundary and the connected crystals are separated so as to become smallest polygons. Column diameter values and crystal diameter values corresponding to column diameter values are measured. An average of the measured diameter values is calculated in the same manner as in determining a “column diameter” in the columnar portion 34 and employed as a “crystal diameter.”

From the viewpoint of image sharpness and sufficient absorption of radiation in the columnar portion 34, it is preferable that the thickness of the columnar portion 34 be in the range of 200 to 700 μm though it depends on the radiation energy. If the columnar portion 34 is too thin, radiation cannot be absorbed sufficiently and hence the sensitivity may be lowered. If the columnar portion 34 is too thick, light diffusion occurs and hence the image sharpness may be lowered even with the light guide effect of the columnar crystals 35.

From the viewpoint of adhesion to the support substrate 11 and light reflection, it is preferable that the thickness of the non-columnar portion 36 be in the range of 5 to 125 μm. If the non-columnar portion 36 is too thin, sufficient adhesion to the support substrate 11 may not be obtained. If the non-columnar portion 36 is too thick, the contribution of fluorescent light in the non-columnar portion 36 and the light diffusion due to reflection in the non-columnar portion 36 are increased and hence the image sharpness may be lowered.

The entire surface, including the fluorescent light emission surface, of the scintillator 18 which is formed in the above-described manner on the support substrate 11 is covered with a moistureproof protective film 19. The scintillator 18 is sealed by the protective film 19 and thereby prevented from becoming deliquescent.

The protective film 19 may be made of parylene. A parylene thin film can easily be formed on the surface of the scintillator 18 by vapor-phase deposition. It is preferable that the thickness of the protective film 19 be in the range of 5 to 25 μm. And it is even preferable that the thickness of the protective film 19 be in the range of 10 to 20 μm. If the protective film 19 is too thick, the distance between the scintillator 18 and the sensor panel 3 becomes long and hence the image sharpness may degrade being affected by scattering or the like occurring between them. On the other hand, if the protective film 19 is too thin, its moistureproofness is reduced to render the scintillator 18 deliquescent and hence the image sharpness may be lowered also in this case. Furthermore, if the protective film 19 is too thin, minute asperities of the fluorescent light emission surface (which is a collection of tip portions of the columnar crystals 35) of the scintillator 18 cannot be reduced, which may lower the adhesion to the adhesive layer 25 and cause local peeling between the scintillator 18 and the sensor panel 3. Local peeling between the scintillator 18 and the sensor panel 3 may render corresponding pixels defective.

The protective film 19 is a film whose surface was subjected to plasma processing and thereby turned hydrophilic. As a result, sufficient adhesion to the adhesive layer 25 is obtained and reduction of the adhesion can be prevented. Even if a warp occurs due to the difference between the linear expansion coefficients of the support substrate 11 and the TFT substrate 16, the scintillator 18 and the sensor panel 3 are not peeled off each other. The durability of the radiological image detection apparatus 1 can thus be made excellent.

Next, an example manufacturing method of the radiation image conversion panel 2 will be described in which it is assumed that CsI:Tl is used as a fluorescent material of the scintillator 18 and the protective film 19 is made of parylene.

The scintillator 18 is formed directly on the surface of the support substrate 11 by vapor-phase deposition. Because of the use of vapor-phase deposition, the non-columnar portion 36 and the columnar portion 34 can be formed continuously in this order into a single body. For example, CsI:Tl is put in a resistance heating crucible and vaporized by heating it by energizing the crucible in an environment that the degree of vacuum is 0.01 to 10 Pa. And CsI:Tl is deposited on the support substrate 11 whose temperature is set at room temperature (20° C.) to 300° C.

At an initial stage of growth of CsI:Tl crystals on the support substrate 11, spherical crystals having relatively small diameters are deposited and a non-columnar portion 36 is formed. Then, a columnar portion 34 is formed continuously to the formation of the non-columnar portion 36 after at least one of the degree of vacuum and the temperature of the support substrate 11 is changed. More specifically, a columnar portion 34 is formed by growing columnar crystals 35 by increasing the degree of vacuum and/or the temperature of the support substrate 11.

In this manner, the scintillator 18 can be manufactured easily and efficiently. This manufacturing method also has an advantage that scintillators 18 of various designs that satisfy various specifications can be manufactured in a simple manner by controlling the degree of vacuum and the temperature of a support substrate that govern film formation of the scintillator 18.

After the formation of the scintillator 18 on the support substrate 11, a parylene protective film 19 is formed on the surface of the scintillator 18 by vapor-phase deposition and the surface of the protective film 19 is subjected to plasma processing.

No limitations are imposed on the plasma processing method as long as a plasma gas can be applied to the surface of the protective film 19. One method is to irradiate the surface of the protective film 19 with plasma using a plasma gun. Other known plasma processing methods such as plasma cleaning and plasma etching that are used in CVD etc. can be used. No limitations are imposed on the gas that is used in the plasma processing as long as it does not react with the surface of the protective film 19. Inert gasses such as He, Ne, and Ar can be used.

No limitations are imposed on the plasma processing conditions either. Atmospheric pressure plasma processing is preferable though low-pressure plasma processing can also be used. Enabling processing in an atmospheric pressure atmosphere, atmospheric pressure plasma processing is advantageous in that in-line/continuous processing is possible and hence the adhesion can be increased to the same degree as or a higher degree than in low-pressure plasma processing though the processing time is shorter than in low-pressure plasma processing. Thus, atmospheric pressure plasma processing is superior in efficiency. In the case of atmospheric pressure plasma processing, it is preferable that the surface temperature of the protective film 19 which is to come into contact with the scintillator 18 be kept lower than 80° C. It is even preferable that the surface temperature be kept lower than or equal to 50° C. This is to avoid heat-induced reduction in the luminous efficiency of the scintillator 18. The luminous efficiency of CsI lowers when it is left in an atmosphere of 80° C. or more for a long time.

As described above, the thus-manufactured radiation image conversion panel 2 is bonded to the sensor panel 3 with the adhesive layer 25 which is disposed between the sensor panel 3 and the plasma-processed protective film 19 which covers the fluorescent light emission surface of the scintillator 18.

No limitations are imposed on the adhesive layer 25 as long as it allows fluorescent light emitted from the scintillator 18 to reach the photoelectric conversion elements 26 without attenuation. For example, the adhesive layer 25 may be made of an adhesive such as a UV-curing adhesive, a heat-curing adhesive, a room-temperature-curing adhesive, or a hot-melt adhesive, or a pressure-sensitive adhesive such as a rubber pressure-sensitive adhesive, a silicone pressure-sensitive adhesive, or an acrylic pressure-sensitive adhesive, or may be a double-sided adhesive or pressure sensitive adhesive sheet both surfaces of which are provided with one of the above adhesives and pressure-sensitive adhesives. Among the above-mentioned adhesives, from the viewpoint of not lowering the image sharpness, it is preferable to use a low-viscosity resin adhesive which enables formation of an adhesive layer that is sufficiently thin for the pixel size. Among the above-mentioned pressure-sensitive adhesives, it is preferable to use an acrylic pressure-sensitive adhesive which is less prone to deteriorate due to oxidation or exposure to light.

It is preferable that the thickness of the adhesive layer 25 be in the range of 10 to 40 μm. It is even preferable that the thickness of the adhesive layer 25 be in the range of 15 to 35 μm. If the adhesive layer 25 is too thick, the distance between the scintillator 18 and the sensor panel 3 becomes long and hence the image quality may degrade being affected by scattering or the like occurring between them. On the other hand, the adhesive layer 25 is too thin, the stress that is caused by a warp is not reduced sufficiently and hence local peeling may occur between the scintillator 18 and the sensor panel 3. Local peeling between the scintillator 18 and the sensor panel 3 may render corresponding pixels defective.

It is preferable that the total thickness of the protective film 19 and the adhesive layer 25 be in the range of 15 to 60 μm taking into consideration peeling between the scintillator 18 and the sensor panel 3 and scattering or the like occurring between them. It is even preferable that the total thickness of the protective film 19 and the adhesive layer 25 be in the range of 20 to 50 μm.

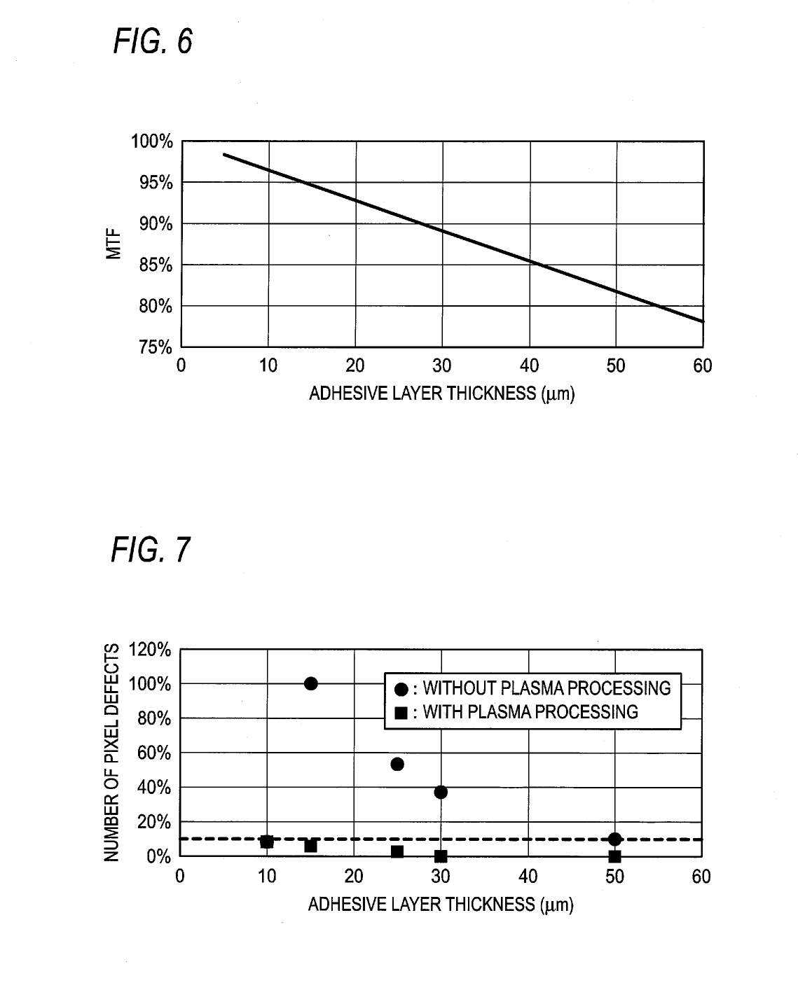

FIG. 6 shows a relationship between the thickness of the adhesive layer 25 and the MTF (modulation transfer function) value in the radiological image detection apparatus 1.

MTF values were obtained by performing calculation on edge images taken by shooting an MTF edge made of tungsten (W) according to an IEC standard. FIG. 6 employs values at 2 cycles/mm which are relative values in percentage obtained by using, as a reference, a value without the adhesive layer 25 (thickness: 0 μm). The thickness of the protective film 19 is fixed to 10 μm.

As seen from FIG. 6, a criterion that the MTF value should be larger than a minimum necessary image sharpness value 85% (allowable MTF reduction ratio: 15% or less) is satisfied if the thickness of the adhesive layer 25 is smaller than or equal to 40 μm. The MTF value depends on the thickness of the adhesive layer 25 but does not depend on whether the protective film 19 was subjected to plasma processing. FIG. 6 shows only MTF values of radiological image detection apparatuses 1 whose protective film 19 were subjected to plasma processing.

FIG. 7 shows a relationship between the thickness of the adhesive layer 25 and the number of pixel defects in the radiological image detection apparatus 1.

FIG. 7 shows the numbers of pixel defects of radiological image detection apparatuses 1 whose protective films 19 were subjected to plasma processing and the numbers of pixel defects of radiological image detection apparatuses whose protective films 19 were not subjected to plasma processing which are relative values in percentage obtained by using, as a reference, the number of pixel defects of a radiological image detection apparatus whose protective film 19 was not subjected to plasma processing and adhesive layer 25 has a thickness 15 μm. The thickness of the protective film 19 is fixed to 10 μm.

As seen from FIG. 7, where the protective film 19 was not subjected to plasma processing, a criterion that the number of pixel defects should be smaller than or equal to 10% is satisfied if the thickness of the adhesive layer 25 is greater than or equal to 50 μm. In contrast, where the protective film 19 was subjected to plasma processing, the same criterion is satisfied if the thickness of the adhesive layer 25 is greater than or equal to 10 μm.

As described above, since the protective film 19 is subjected to plasma processing, the adhesion between the protective film 19 and the adhesive layer 25 is increased, whereby the scintillator 18 and the sensor panel 3 are prevented from peeling off each other. As a result, the adhesive layer 25 can be made thinner and hence the image sharpness can be increased.

Although in the above-described radiological image detection apparatus 1 only the protective film 19 is subjected to plasma processing, the planarization layer 23 of the sensor panel 3 may also be subjected to plasma processing, in which case the adhesion between the adhesive layer 25 and the sensor panel 3 is increased and hence the image quality and the durability can be increased.

Although in the above-described radiological image detection apparatus 1 radiation is input from the side of the sensor panel 3, a configuration is possible in which radiation is input from the side of the radiation image conversion panel 2.

Since the aforementioned radiological image detection apparatus can detect a radiological image with high sensitivity and high definition, it can be installed and used in an X-ray imaging apparatus for the purpose of medical diagnosis, such as a mammography apparatus, required to detect a sharp image with a low dose of radiation, and other various apparatuses. For example, the radiological image detection apparatus is applicable to an industrial X-ray imaging apparatus for nondestructive inspection, or an apparatus for detecting particle rays (α-rays, β-rays, γ-rays) other than electromagnetic waves. The radiological image detection apparatus has a wide range of applications.

Description will be made below on materials which can be used for constituent members of the sensor panel 3.

### [Photoelectric Conversion Element]

Inorganic semiconductor materials such as amorphous silicon are often used for the photoconductive layer 20 (see FIG. 1) of the aforementioned photoelectric conversion elements 26. For example, any OPC (Organic Photoelectric Conversion) material disclosed in JP-A-2009-32854 may be used. A film formed out of the OPC material (hereinafter referred to as OPC film) may be used as the photoconductive layer 20. The OPC film contains an organic photoelectric conversion material, absorbing light emitted from a phosphor layer and generating electric charges in accordance with the absorbed light. Such an OPC film containing an organic photoelectric conversion material has a sharp absorption spectrum in a visible light range. Thus, electromagnetic waves other than light emitted from the phosphor layer are hardly absorbed by the OPC film, but noise generated by radiation such as X-rays absorbed by the OPC film can be suppressed effectively.

It is preferable that the absorption peak wavelength of the organic photoelectric conversion material forming the OPC film is closer to the peak wavelength of light emitted by the phosphor layer in order to more efficiently absorb the light emitted by the phosphor layer. Ideally, the absorption peak wavelength of the organic photoelectric conversion material agrees with the peak wavelength of the light emitted by the phosphor layer. However, if the difference between the absorption peak wavelength of the organic photoelectric conversion material and the peak wavelength of the light emitted by the phosphor layer is small, the light emitted by the phosphor layer can be absorbed satisfactorily. Specifically, the difference between the absorption peak wavelength of the organic photoelectric conversion material and the peak wavelength of the light emitted by the phosphor layer in response to radioactive rays is preferably not larger than 10 nm, more preferably not larger than 5 nm.

Examples of the organic photoelectric conversion material that can satisfy such conditions include arylidene-based organic compounds, quinacridone-based organic compounds, and phthalocyanine-based organic compounds. For example, the absorption peak wavelength of quinacridone in a visible light range is 560 nm. Therefore, when quinacridone is used as the organic photoelectric conversion material and CsI(Tl) is used as the phosphor layer material, the aforementioned difference in peak wavelength can be set within 5 nm so that the amount of electric charges generated in the OPC film can be increased substantially to the maximum.

At least a part of an organic layer provided between the bias electrode 22 and the charge collection electrode 24 can be formed out of an OPC film. More specifically, the organic layer can be formed out of a stack or a mixture of a portion for absorbing electromagnetic waves, a photoelectric conversion portion, an electron transport portion, an electron hole transport portion, an electron blocking portion, an electron hole blocking portion, a crystallization prevention portion, electrodes, interlayer contact improvement portions, etc.

Preferably the organic layer contains an organic p-type compound or an organic n-type compound. An organic p-type semiconductor (compound) is a donor-type organic semiconductor (compound) as chiefly represented by an electron hole transport organic compound, meaning an organic compound having characteristic to easily donate electrons. More in detail, of two organic materials used in contact with each other, one with lower ionization potential is called the donor-type organic compound. Therefore, any organic compound may be used as the donor-type organic compound as long as the organic compound having characteristic to donate electrons. Examples of the donor-type organic compound that can be used include a triarylamine compound, a benzidine compound, a pyrazoline compound, a styrylamine compound, a hydrazone compound, a triphenylmethane compound, a carbazole compound, a polysilane compound, a thiophene compound, a phthalocyanine compound, a cyanine compound, a merocyanine compound, an oxonol compound, a polyamine compound, an indole compound, a pyrrole compound, a pyrazole compound, a polyarylene compound, a fused aromatic carbocyclic compound (naphthalene derivative, anthracene derivative, phenanthrene derivative, tetracene derivative, pyrene derivative, perylene derivative, fluoranthene derivative), a metal complex having a nitrogen-containing heterocyclic compound as a ligand, etc. The donor-type organic semiconductor is not limited thereto but any organic compound having lower ionization potential than the organic compound used as an n-type (acceptor-type) compound may be used as the donor-type organic semiconductor.

The n-type organic semiconductor (compound) is an acceptor-type organic semiconductor (compound) as chiefly represented by an electron transport organic compound, meaning an organic compound having characteristic to easily accept electrons. More specifically, when two organic compounds are used in contact with each other, one of the two organic compounds with higher electron affinity is the acceptor-type organic compound. Therefore, any organic compound may be used as the acceptor-type organic compound as long as the organic compound having characteristic to accept electrons. Examples thereof include a fused aromatic carbocyclic compound (naphthalene derivative, anthracene derivative, phenanthrene derivative, tetracene derivative, pyrene derivative, perylene derivative, fluoranthene derivative), a 5- to 7-membered heterocyclic compound containing a nitrogen atom, an oxygen atom or a sulfur atom (e.g. pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyralidine, pyrrolopyridine, thiadiazolopyridine, dibenzazepine, tribenzazepine etc.), a polyarylene compound, a fluorene compound, a cyclopentadiene compound, a silyl compound, and a metal complex having a nitrogen-containing heterocyclic compound as a ligand. The acceptor-type organic semiconductor is not limited thereto. Any organic compound may be used as the acceptor-type organic semiconductor as long as the organic compound has higher electron affinity than the organic compound used as the donor-type organic compound.

As for p-type organic dye or n-type organic dye, any known dye may be used. Preferred examples thereof include cyanine dyes, styryl dyes, hemicyanine dyes, merocyanine dyes (including zero-methine merocyanine (simple merocyanine)), trinuclear merocyanine dyes, tetranuclear merocyanine dyes, rhodacyanine dyes, complex cyanine dyes, complex merocyanine dyes, alopolar dyes, oxonol dyes, hemioxonol dyes, squarylium dyes, croconium dyes, azamethine dyes, coumarin dyes, arylidene dyes, anthraquinone dyes, triphenylmethane dyes, azo dyes, azomethine dyes, Spiro compounds, metallocene dyes, fluorenone dyes, flugide dyes, perylene dyes, phenazine dyes, phenothiazine dyes, quinone dyes, indigo dyes, diphenylmethane dyes, polyene dyes, acridine dyes, acridinone dyes, diphenylamine dyes, quinacridone dyes, quinophthalone dyes, phenoxazine dyes, phthaloperylene dyes, porphyrin dyes, chlorophyll dyes, phthalocyanine dyes, metal complex dyes, and fused aromatic carbocyclic dyes (naphthalene derivative, anthracene derivative, phenanthrene derivative, tetracene derivative, pyrene derivative, perylene derivative, fluoranthene derivative).

A photoelectric conversion film (photosensitive layer) which has a layer of a p-type semiconductor and a layer of an n-type semiconductor between a pair of electrodes and at least one of the p-type semiconductor and the n-type semiconductor is an organic semiconductor and in which a bulk heterojunction structure layer including the p-type semiconductor and the n-type semiconductor is provided as an intermediate layer between those semiconductor layers may be used preferably. The bulk heterojunction structure layer included in the photoelectric conversion film can cover the defect that the carrier diffusion length of the organic layer is short. Thus, the photoelectric conversion efficiency can be improved. The bulk heterojunction structure has been described in detail in JP-A-2005-303266.

It is preferable that the photoelectric conversion film is thicker in view of absorption of light from the phosphor layer. The photoelectric conversion film is preferably not thinner than 30 nm and not thicker than 300 nm, more preferably not thinner than 50 nm and not thicker than 250 nm, particularly more preferably not thinner than 80 nm and not thicker than 200 nm in consideration of the ratio which does make any contribution to separation of electric charges.

As for any other configuration about the aforementioned OPC film, for example, refer to description in JP-A-2009-32854.

### [Switching Device]

Inorganic semiconductor materials such as amorphous silicon are often used for an active layer of each switching device 28. However, any organic material, for example, as disclosed in JP-A-2009-212389, may be used. Although the organic TFT may have any type of structure, a field effect transistor (FET) structure is the most preferable. In the FET structure, a gate electrode is provided on a part of an upper surface of an insulating substrate, and an insulator layer is provided to cover the electrode and touch the substrate in the other portion than the electrode. Further, a semiconductor active layer is provided on an upper surface of the insulator layer, and a transparent source electrode and a transparent drain electrode are disposed on a part of an upper surface of the semiconductor active layer and at a distance from each other. This configuration is called a top contact type device. However, a bottom contact type device in which a source electrode and a drain electrode are disposed under a semiconductor active layer may be also used preferably. In addition, a vertical transistor structure in which a carrier flows in the thickness direction of an organic semiconductor film may be used.

### (Active Layer)

Organic semiconductor materials mentioned herein are organic materials showing properties as semiconductors. Examples of the organic semiconductor materials include p-type organic semiconductor materials (or referred to as p-type materials simply or as electron hole transport materials) which conduct electron holes (holes) as carriers, and n-type organic semiconductor materials (or referred to as n-type materials simply or as electrode transport materials) which conduct electrons as carriers, similarly to a semiconductor formed out of an inorganic material. Of the organic semiconductor materials, lots of p-type materials generally show good properties. In addition, p-type transistors are generally excellent in operating stability as transistors under the atmosphere. Here, description here will be made on a p-type organic semiconductor material.

One of properties of organic thin film transistors is a carrier mobility (also referred to as mobility simply) μ which indicates the mobility of a carrier in an organic semiconductor layer. Although preferred mobility varies in accordance with applications, higher mobility is generally preferred. The mobility is preferably not lower than 1.0*10⁻⁷ cm²/Vs, more preferably not lower than 1.0*10⁻⁶ cm²/Vs, further preferably not lower than 1.0*10⁻⁵ cm²/Vs. The mobility can be obtained by properties or TOF (Time Of Flight) measurement when the field effect transistor (FET) device is manufactured.

The p-type organic semiconductor material may be either a low molecular weight material or a high molecular weight material, but preferably a low molecular weight material. Lots of low molecular weight materials typically show excellent properties due to easiness in high purification because various refining processes such as sublimation refining, recrystallization, column chromatography, etc. can be applied thereto, or due to easiness in formation of a highly ordered crystal structure because the low molecular weight materials have a fixed molecular structure. The molecular weight of the low molecular weight material is preferably not lower than 100 and not higher than 5,000, more preferably not lower than 150 and not higher than 3,000, further more preferably not lower than 200 and not higher than 2,000.

A phthalocyanine compound or a naphthalocyanine compound may be exemplified as such a p-type organic semiconductor material. A specific example thereof is shown as follows. M represents a metal atom, Bu represents a butyl group, Pr represents a propyl group, Et represents an ethyl group, and Ph represents a phenyl group.

[Chemical 1]

| | |
|---|---|
| 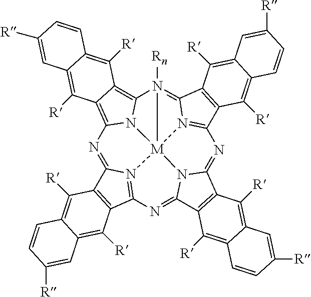 | Compound 1 to 15 |
| 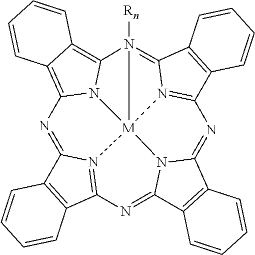 | Compound 16 to 20 |

| Compound | M | R | N | R′ | R″ |
|---|---|---|---|---|---|
| 1 | Si | OSi(n-Bu)₃ | 2 | H | H |
| 2 | Si | OSi(i-Pr)₃ | 2 | H | H |
| 3 | Si | OSi(OEt)₃ | 2 | H | H |
| 4 | Si | OSiPh₃ | 2 | H | H |
| 5 | Si | O(n-C₈H₁₇) | 2 | H | H |
| 7 | Ge | OSi(n-Bu)₃ | 2 | H | H |
| 8 | Sn | OSi(n-Bu)₃ | 2 | H | H |
| 9 | Al | OSi(n-C₆H₁₃)₃ | 1 | H | H |
| 10 | Ga | OSi(n-C₆H₁₃)₃ | 1 | H | H |
| 11 | Cu | — | — | O(n-Bu) | H |
| 12 | Ni | — | — | O(n-Bu) | H |
| 13 | Zn | — | — | H | t-Bu |
| 14 | V═O | — | — | H | t-Bu |
| 15 | H₂ | — | — | H | t-Bu |
| 16 | Si | OSiEt₃ | 2 | — | — |
| 17 | Ge | OSiEt₃ | 2 | — | — |
| 18 | Sn | OSiEt₃ | 2 | — | — |
| 19 | Al | OSiEt₃ | 1 | — | — |
| 20 | Ga | OSiEt₃ | 1 | — | — |

### (Constituent Members of Switching Device Other Than Active Layer)

The material forming the gate electrode, the source electrode or the drain electrode is not limited particularly if it has required electric conductivity. Examples thereof include: transparent electrically conductive oxides such as ITO (indium-doped tin oxide), IZO (indium-doped zinc oxide), SnO₂, ATO (antimony-doped tin oxide), ZnO, AZO (aluminum-doped zinc oxide), GZO (gallium-doped zinc oxide), TiO₂, FTO (fluorine-doped tin oxide), etc.; transparent electrically conductive polymers such as PEDOT/PSS (poly(3,4-ethylenedioxythiophene)/polystyrenesulfonate); carbon materials such as carbon nanotube; etc. These electrode materials may be formed into films, for example, by a vacuum deposition method, sputtering, a solution application method, etc.

The material used for the insulating layer is not limited particularly as long as it has required insulating effect. Examples thereof include: inorganic materials such as silicon dioxide, silicon nitride, alumina, etc.; and organic materials such as polyester (PEN (polyethylene naphthalate), PET (polyethylene terephthalate) etc.), polycarbonate, polyimide, polyamide, polyacrylate, epoxy resin, polyparaxylylene resin, novolak resin, PVA (polyvinyl alcohol), PS (polystyrene), etc. These insulating film materials may be formed into films, for example, by a vacuum deposition method, sputtering, a solution application method, etc.

As for any other configuration about the aforementioned organic TFT, for example, refer to the description in JP-A-2009-212389.

In addition, for example, amorphous oxide disclosed in JP-A-2010-186860 may be used for the active layer of the switching devices 28. Here, description will be made on an amorphous oxide containing active layer belonging to an FET transistor disclosed in JP-A-2010-186860. The active layer serves as a channel layer of the FET transistor where electrons or holes can move.

The active layer is configured to contain an amorphous oxide semiconductor. The amorphous oxide semiconductor can be formed into a film at a low temperature. Thus, the amorphous oxide semiconductor can be formed preferably on a flexible substrate. The amorphous oxide semiconductor used for the active layer is preferably of amorphous oxide containing at least one kind of element selected from a group consisting of In, Sn, Zn and Cd, more preferably of amorphous oxide containing at least one kind of element selected from a group consisting of In, Sn and Zn, further preferably of amorphous oxide containing at least one kind of element selected from a group consisting of In and Zn.

Specific examples of the amorphous oxide used for the active layer include In₂O₃, ZnO, SnO₂, CdO, Indium-Zinc-Oxide (IZO), Indium-Tin-Oxide (ITO), Gallium-Zinc-Oxide (GZO), Indium-Gallium-Oxide (IGO), and Indium-Gallium-Zinc-Oxide (IGZO).

It is preferable that a vapor phase film formation method targeting at a polycrystal sinter of the oxide semiconductor is used as a method for forming the active layer. Of vapor phase film formation methods, a sputtering method or a pulse laser deposition (PLD) method is suitable. Further, the sputtering method is preferred in view from mass productivity. For example, the active layer is formed by an RF magnetron sputtering deposition method with a controlled degree of vacuum and a controlled flow rate of oxygen.

By a known X-ray diffraction method, it can be confirmed that the active layer formed into a film is an amorphous film. The composition ratio of the active layer is obtained by an RBS (Rutherford Backscattering Spectrometry) method.

In addition, the electric conductivity of the active layer is preferably lower than 10² Scm⁻¹ and not lower than 10⁻⁴ Scm⁻¹, more preferably lower than 10² Scm⁻¹ and not lower than 10⁻¹ Scm⁻¹. Examples of the method for adjusting the electric conductivity of the active layer include an adjusting method using oxygen deficiency, an adjusting method using a composition ratio, an adjusting method using impurities, and an adjusting method using an oxide semiconductor material, as known.

As for any other configuration about the aforementioned amorphous oxide, for example, refer to description in JP-A-2010-186860.

### [Insulative Substrate]

The insulative substrate may be a glass substrate, a quartz substrate, a plastic film, or the like. Example materials of the plastic film are polyethylene terephthalate (PET), polyethylene naphthalate (PEN), polyethersulfone (PES), polyetherimide, polyetherketone, polyphenylene sulfide, polyarylate, polyimide, polycarbonate (PC), cellulose triacetate (TAC), and cellulose acetate propionate (CAP). The plastic film made of any of the above materials may contain an organic or inorganic filler. A flexible substrate which is made of aramid, bionanofiber, or the like and exhibits characteristics (e.g., high flexibility, low thermal expansion, and high strength) that cannot be obtained by existing glass or plastic substrates can also be used suitably as the insulative substrate.

### (Aramid)

An aramid material has high heat resistance showing a glass transition temperature of 315° C., high rigidity showing a Young's modulus of 10 GPa, and high dimensional stability showing a thermal expansion coefficient of −3 to 5 ppm/° C. Therefore, when a film made from aramid is used, it is possible to easily form a high-quality film for a semiconductor layer, as compared with the case where a general resin film is used. In addition, due to the high heat resistance of the aramid material, an electrode material can be cured at a high temperature to have low resistance. Further, it is also possible to deal with automatic mounting with ICs, including a solder reflow step. Furthermore, since the aramid material has a thermal expansion coefficient close to that of ITO (indium tin oxide), a gas barrier film or a glass substrate, warp after manufacturing is small. In addition, cracking hardly occurs. Here, it is preferable to use a halogen-free (in conformity with the requirements of JPCA-ES01-2003) aramid material containing no halogens, in view of reduction of environmental load.

The aramid film may be laminated with a glass substrate or a PET substrate, or may be pasted onto a housing of a device.

High intermolecular cohesion (hydrogen bonding force) of aramid leads to low solubility to a solvent. When the problem of the low solubility is solved by molecular design, an aramid material easily formed into a colorless and transparent thin film can be used preferably. Due to molecular design for controlling the order of monomer units and the substituent species and position on an aromatic ring, easy formation with good solubility can be obtained with the molecular structure kept in a bar-like shape with high linearity leading to high rigidity or dimensional stability of the aramid material. Due to the molecular design, halogen-free can be also achieved.

In addition, an aramid material having an optimized characteristic in an in-plane direction of a film can be used preferably. Tensional conditions are controlled in each step of solution casting, vertical drawing and horizontal drawing in accordance with the strength of the aramid film which varies constantly during casting. Due to the control of the tensional conditions, the in-plane characteristic of the aramid film which has a bar-like molecular structure with high linearity leading to easy occurrence of anisotropic physicality can be balanced.

Specifically, in the solution casting step, the drying rate of the solvent is controlled to make the in-plane thickness-direction physicality isotropic and optimize the strength of the film including the solvent and the peel strength from a casting drum. In the vertical drawing step, the drawing conditions are controlled precisely in accordance with the film strength varying constantly during drawing and the residual amount of the solvent. In the horizontal drawing, the horizontal drawing conditions are controlled in accordance with a change in film strength varying due to heating and controlled to relax the residual stress of the film. By use of such an aramid material, the problem that the aramid film after casting may be curled.

In each of the contrivance for the easiness of casting and the contrivance for the balance of the film in-plane characteristic, the bar-like molecular structure with high linearity peculiar to aramid can be kept to keep the thermal expansion coefficient low. When the drawing conditions during film formation are changed, the thermal expansion coefficient can be reduced further.

### (Bionanofiber)

Nanofiber components that are sufficiently small with respect to the wavelength of light do not cause light scattering and hence can be used for reinforcing a transparent and flexible resin material. Among various kinds of nanofiber, cellulose microfibril bundles produced by bacteria (Acetobacter xylinum) have features that their sizes (width: 50 nm) are about 1/10 of the visible light wavelengths and they are high in strength and elasticity and low in thermal expansion. Therefore, composite materials (sometimes called bionanofibers) of such bacteria cellulose and a transparent resin can be used suitably.

When a bacterial cellulose sheet is impregnated with transparent resin such as acrylic resin or epoxy resin and hardened, transparent bionanofiber showing a light transmittance of about 90% in a wavelength of 500 nm while having a high fiber ratio of about 60 to 70% can be obtained. By the bionanofiber, a thermal expansion coefficient (about 3 to 7 ppm) as low as that of silicon crystal, strength (about 460 MPa) as high as that of steel, and high elasticity (about 30 GPa) can be obtained.

As for the configuration about the aforementioned bionanofiber, for example, refer to description in JP-A-2008-34556.

### [Planarization Layer]

No limitations are imposed on the planarization layer 23 as long as it allows fluorescent light emitted from the scintillator 18 to reach the photoelectric conversion elements 26 without attenuation. The planarization layer 23 may be made of a resin such as polyimide or parylene, and it is preferable to use polyimide which provides good film formation performance.

As discussed above, the specification discloses the following radiological image detection apparatus and method of manufacturing the radiological image detection apparatus.

(1) A radiological image detection apparatus includes: a radiation image conversion panel including: a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, a surface of the protective film being subjected to plasma processing; a sensor panel detecting the fluorescent light emitted from the phosphor; and an adhesive layer which is sandwiched between the protective film and a photodetecting surface of the sensor panel and with which the radiation image conversion panel and the sensor panel are bonded to each other, a thickness of the adhesive layer being in a range of 10 to 40 μm.

(2) In the radiological image detection apparatus according to (1), the thickness of the adhesive layer may be in a range of 15 to 35 μm.

(3) In the radiological image detection apparatus according to (1), a thickness of the protective film may be in a range of 5 to 25 μm.

(4) In the radiological image detection apparatus according to (3), the thickness of the protective film may be in a range of 10 to 20 μm.

(5) In the radiological image detection apparatus according to (1), a total thickness of the adhesive layer and the protective film may be in a range of 15 to 60 μm.

(6) In the radiological image detection apparatus according to (5), the total thickness of the adhesive layer and the protective film may be in a range of 20 to 50 μm.

(7) In the radiological image detection apparatus according to (1), the fluorescent light emission surface of the phosphor may be a collection of tip portions of the columnar crystals.

(8) In the radiological image detection apparatus according to (1), a surface of the photodetecting surface of the sensor panel may be subjected to plasma processing.

(9) The radiological image detection apparatus according to (1), the fluorescent material of the phosphor may be CsI:Tl.

(10) In the radiological image detection apparatus according to (1), the protective film may be made of parylene.

(11) In the radiological image detection apparatus according to (1), the adhesive layer may include a low-viscosity resin adhesive.

(12) In the radiological image detection apparatus according to (1), the adhesive layer may include an acrylic pressure-sensitive adhesive.

(13) A method of manufacturing a radiological image detection apparatus comprising: a radiation image conversion panel including a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, and a sensor panel detecting the fluorescent light emitted from the phosphor, includes: subjecting a surface of the protective film to plasma processing; and bonding the radiation image conversion panel and the sensor panel to each other with an adhesive layer which is sandwiched between the plasma-processed surface of the protective film and the photodetecting surface of the sensor panel and has a thickness that is in a range of 10 to 40 μm.

(14) In the method of manufacturing the radiological image detection apparatus according to (13), the plasma processing may be atmospheric pressure plasma processing.

(15) In the method of manufacturing the radiological image detection apparatus according to (14), a surface temperature of the protective film may be kept lower than 80° C. during the atmospheric pressure plasma processing.

(16) In the method of manufacturing the radiological image detection apparatus according to (15), the surface temperature of the protective film is kept lower than or equal to 50° C. during the atmospheric pressure plasma processing.

What is claimed is:

1. A radiological image detection apparatus comprising:
a radiation image conversion panel including:
a phosphor having a group of columnar crystals in which crystals of the fluorescent material have grown into columnar shape, the fluorescent material which emits fluorescent light when exposed to radiation and
a protective film which covers at least a fluorescent light emission surface of the phosphor, a surface of the protective film being subjected to plasma processing;
a sensor panel detecting the fluorescent light emitted from the phosphor; and
an adhesive layer which is sandwiched between the protective film and a photodetecting surface of the sensor panel and with which the radiation image conversion panel and the sensor panel are bonded to each other, a thickness of the adhesive layer being in a range of 10 to 40 μm.

2. The radiological image detection apparatus according to claim 1, wherein:
the thickness of the adhesive layer is in a range of 15 to 35 μm.

3. The radiological image detection apparatus according to claim 1, wherein:
a thickness of the protective film is in a range of 5 to 25 μm.

4. The radiological image detection apparatus according to claim 3, wherein:
the thickness of the protective film is in a range of 10 to 20 μm.

5. The radiological image detection apparatus according to claim 1, wherein:
a total thickness of the adhesive layer and the protective film is in a range of 15 to 60 μm.

6. The radiological image detection apparatus according to claim 5, wherein:
the total thickness of the adhesive layer and the protective film is in a range of 20 to 50 μm.

7. The radiological image detection apparatus according to claim 1, wherein:
the fluorescent light emission surface of the phosphor is a collection of tip portions of the columnar crystals.

8. The radiological image detection apparatus according to claim 1, wherein:
a surface of the photodetecting surface of the sensor panel was subjected to plasma processing.

9. The radiological image detection apparatus according to claim 1, wherein:
the fluorescent material of the phosphor is CsI:Tl.

10. The radiological image detection apparatus according to claim 1, wherein:
the protective film is made of parylene.

11. The radiological image detection apparatus according to claim 1, wherein:
the adhesive layer includes a low-viscosity resin adhesive.

12. The radiological image detection apparatus according to claim 1, wherein:
the adhesive layer includes an acrylic pressure-sensitive adhesive.

13. A method of manufacturing a radiological image detection apparatus comprising: a radiation image conversion panel including a phosphor having a group of columnar crystals in which crystals of the fluorescent material have grown into columnar shape, the fluorescent material which emits fluorescent light when exposed to radiation and a protective film which covers at least a fluorescent light emission surface of the phosphor, and a sensor panel detecting the fluorescent light emitted from the phosphor, comprising:
subjecting a surface of the protective film to plasma processing; and
bonding the radiation image conversion panel and the sensor panel to each other with an adhesive layer which is sandwiched between the plasma-processed surface of the protective film and the photodetecting surface of the sensor panel and has a thickness that is in a range of 10 to 40 μm.

14. The method of manufacturing the radiological image detection apparatus according to claim 13, wherein:
the plasma processing is atmospheric pressure plasma processing.

15. The method of manufacturing the radiological image detection apparatus according to claim 14, wherein:
a surface temperature of the protective film is kept lower than 80° C. during the atmospheric pressure plasma processing.

16. The method of manufacturing the radiological image detection apparatus according to claim 15, wherein:
the surface temperature of the protective film is kept lower than or equal to 50° C. during the atmospheric pressure plasma processing.
